(19) United States
(12) Patent Application Publication
(10) Pub. No.: US 2014/0202422 A1
(43) Pub. Date: Jul. 24, 2014

(54) CONTROLLING CYLINDER USAGE DURING REDUCED LOAD ON AN INTERNAL COMBUSTION PROPULSION ENGINE

(71) Applicants: Luis Carlos Cattani, Aurora, IL (US); Laura M Ricart-Ugaz, Chicago, IL (US); Qianfan Xin, Lake Zurich, IL (US)

(72) Inventors: Luis Carlos Cattani, Aurora, IL (US); Laura M Ricart-Ugaz, Chicago, IL (US); Qianfan Xin, Lake Zurich, IL (US)

(73) Assignee: International Engine Intellectual Property Company, LLC, Lisel, IL (US)

(21) Appl. No.: 14/240,463

(22) PCT Filed: Aug. 23, 2011
(86) PCT No.: PCT/US11/48745

§ 371 Date: Feb. 24, 2014

(51) Int. Cl. F02D 13/02

(52) U.S. Cl. CPC F02D 13/0203
USPC 123/321

(57) ABSTRACT

While an engine is miming with all engine cylinders being fueled, a historical record of engine output torque and engine speed is compiled. When the historical record discloses a change in engine operation from a relatively greater output torque and engine speed to a relatively lesser output torque and speed, fueling of at least one engine cylinder ceases while engine output torque and engine speed remain substantially unchanged at the relatively lesser output torque and speed by continuing fueling of other engine cylinders and by causing at least one mechanism to control the timing of operation of cylinder intake and exhaust valves of the at least one engine cylinder to substantially minimize pumping loss attributable to the at least one engine cylinder.

### TECHNICAL FIELD

The general technical field to which this disclosure relates comprises internal combustion engines and motor vehicles which are propelled by internal combustion engines, especially, but not exclusively, large truck vehicles which are propelled by diesel engines.

The subject matter which is disclosed herein relates to a system and method for switching operation of a multi-cylinder internal combustion engine from a first mode in which all cylinders are fueled to a second mode in which fewer than all cylinders are fueled but the engine continues to satisfy substantially the same load which the engine was satisfying in the first mode at the time of switching from the first mode to the second mode.

### BACKGROUND

A highway tractor is an example of a large truck vehicle which is propelled by an internal combustion engine, commonly a turbocharged diesel engine, for towing one or more trailers along roadways. In the United States large highway tractors are categorized as Class 8 vehicles and typically used to tow cargo-carrying trailers along routes which include significant lengths of interstate highways.

The load which is imposed on a highway tractor's propulsion engine during travel along an interstate highway depends on various factors which include both road speed of the tractor and the geography of the route. Significant portions of interstate highways in the United States extend across relatively flat terrain, as is the case in large areas of Midwestern and Southern states.

During a typical long haul trip across relatively flat terrain, the load imposed on a highway tractor's engine is significantly less than the load imposed when the highway tractor is climbing an uphill grade while towing a cargo-carrying trailer. The size of the propulsion engine of a highway tractor is typically selected on the basis of maximum load expected to be encountered in the geographical area in which the highway tractor operates, yet statistics show that a majority of a highway tractor's operation imposes a load on its propulsion engine which is significantly less than the engine's maximum load rating.

When a highway tractor is stopped, its engine may nonetheless be kept running for any of various reasons. One reason is when cargo is being loaded into or unloaded from a trailer. Another reason is when the driver stops to rest, eat, or attend to other matters.

The propulsion engine of a highway tractor which comprises a sleeper cab may be kept running to provide heat for a sleeper compartment during cold weather and/or for operating a generator that keeps a battery bank charged for supplying electricity to electrical equipment. Instead of running the propulsion engine to satisfy those needs, a highway tractor may have an auxiliary power unit (APU) comprising its own smaller diesel engine which operates when the larger propulsion engine is shut off for the purpose of operating its own electric generator to supply electricity to electrical equipment, and/or of providing heat to the sleeper cab interior.

### SUMMARY

Briefly, the motor vehicle and the engine which are the subject of this disclosure comprise a system and method for controlling engine cylinder usage and timing of operation of engine cylinder valves when the load on the engine decreases from a relatively larger magnitude which was being satisfied by fueling all engine cylinders to a relatively smaller magnitude. Instead of continuing to fuel all engine cylinders with a lesser quantity of fuel in each cylinder at the reduced load, fewer than all engine cylinders are fueled with a suitable quantity of fuel to satisfy the reduced load while at least one other engine cylinder is not fueled.

Such reduced load demands are imposed on a vehicle's propulsion engine in various situations, such as when a vehicle commences cruising at fairly steady road speed along relatively flat terrain after having been accelerated to cruising speed, or when the vehicle has been decelerated to a temporary stop in traffic but the propulsion engine continues to idle, or when the vehicle has been parked but the propulsion engine continues to operate at or somewhat above idle speed for the purpose of supplying heat to an occupant compartment and/or electricity to electrical equipment.

The system and method which are the subject of this disclosure involve decreasing the number of engine cylinders of a multi-cylinder internal combustion engine which are used to operate the engine when certain reductions in load on the engine occur. When such a load reduction occurs while the engine is operating in a first mode during which all engine cylinders are being fueled, engine operation can be switched to a second mode during which fueling of at least one engine cylinder stops so that the engine then continues to operate but on fewer than all engine cylinders. An engine cylinder which is not being fueled while the engine continues to operate is referred to a de-activated engine cylinder.

If the engine is switched to begin operating in the second mode, engine cylinders which continue to be fueled (active engine cylinders) and the timing of operation of at least some engine cylinder valves (cylinder intake valves and/or cylinder exhaust valves), which may include engine cylinder valves of active engine cylinders and/or de-activated engine cylinders, are controlled by a comprehensive control strategy in a manner which causes the engine to continue satisfying the load on the engine which it was satisfying at the time its operation was switched from the first mode to the second mode. The effect of this is to reduce the engine's operational displacement.

When the engine is operating in the first mode, engine load data and engine speed data are monitored at sufficiently frequent time intervals to create a historical record of engine operation which is used to disclose when the mode can be switched from the first mode to the second mode without significantly affecting the ability of the engine to continue satisfying the load.

If the engine is switched to operate in the second mode, the historical record continues to be compiled. If the load on the engine decreases even further, the control strategy can vary fueling of active engine cylinders and timing of operation of certain engine cylinder valves appropriate to the reduced load while the engine continues to operate in the second mode.

A sufficiently large reduction in load may cause the historical record of engine operation which is being compiled during operation in the second mode to disclose that engine operation can be switched from the second mode to a third mode during which at least one additional engine cylinder would be de-activated while the control strategy would fuel the still-active engine cylinders and control timing of operation of engine cylinder valves without significantly affecting the ability of the engine to continue satisfying the load which was being satisfied when the historical record disclosed that the mode could be switched from the second mode to the third mode.

One general aspect of the claimed subject matter relates to the engine defined by independent Claim 1.

Another general aspect of the claimed subject matter relates to the method defined by independent Claim 5.

Another general aspect of the claimed subject matter relates to the method defined by independent Claim 8.

The foregoing summary is accompanied by further detail of the disclosure presented in the Detailed Description below with reference to the following drawings that are part of the disclosure.

### BRIEF DESCRIPTION OF THE DRAWINGS

FIG. 1 shows a truck vehicle having an internal combustion propulsion engine which embodies a system and method for controlling engine cylinder usage.

FIG. 2 is a general schematic diagram of the propulsion engine.

FIG. 3 illustrates a representative load model for the propulsion engine when operating at full displacement.

FIG. 4 illustrates two sets of engine operating conditions with reference to FIG. 3.

### DETAILED DESCRIPTION

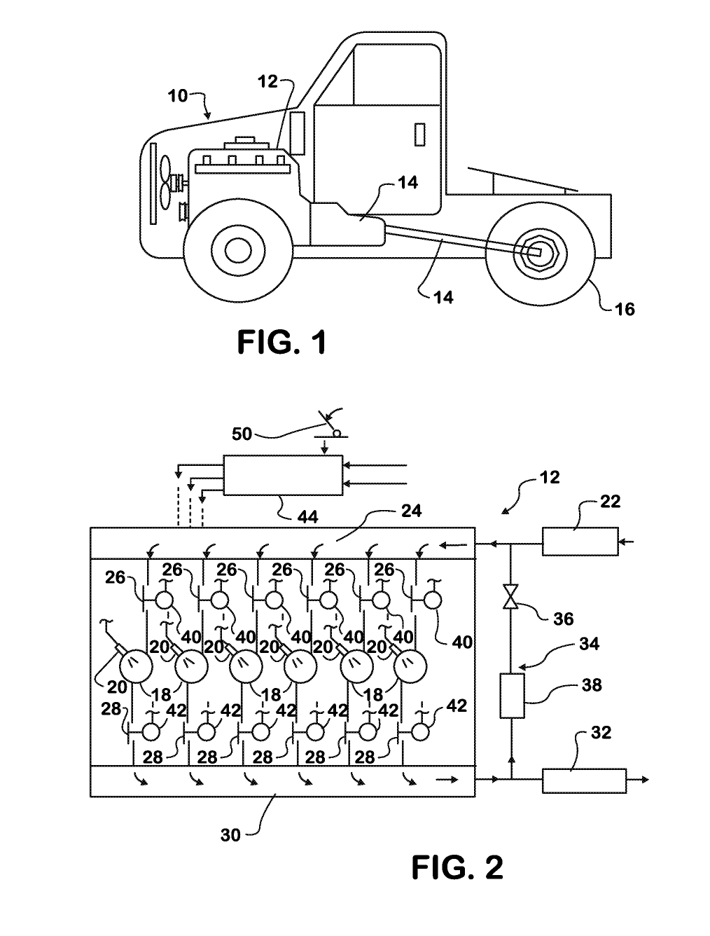

FIG. 1 shows a truck vehicle 10 which is propelled by a multi-cylinder internal combustion propulsion engine 12 operating to deliver torque through a drivetrain 14 to drive wheels 16.

FIG. 2 shows multi-cylinder internal combustion propulsion engine 12 as a diesel engine which comprises structure forming engine cylinders 18 (six are schematically portrayed only as an example) into which fuel is injected by fuel injectors 20 to combust with air which has entered engine cylinders 18 through an intake system 22. Engine 12 comprises an intake manifold 24 for conveying air which has passed through intake system 22 to engine cylinders 18 and cylinder intake valves 26 for controlling admission of air from intake manifold 24 into respective engine cylinders 18.

Intake system 22 may include further components which are not specifically shown in FIG. 2, such as an intake throttle valve, at least one compressor for elevating pressure in intake manifold 24 to superatmospheric pressure, and at least one heat exchanger (sometimes called a cooler) for removing some heat of compression of air that has been compressed.

Engine 12 further comprises cylinder exhaust valves 28 for controlling admission of exhaust from respective engine cylinders 18 into an exhaust manifold 30 for further conveyance through an exhaust system 32.

Exhaust system 32 may include components which are not specifically shown in FIG. 2, such as at least one turbine which is coupled by a respective shaft to operate a respective compressor, and an after-treatment system for treating exhaust before it passes into the surrounding atmosphere.

Engine 12 further comprises an exhaust gas recirculation (EGR) system 34 which serves to convey a portion of exhaust from exhaust system 32 to intake system 22. EGR system 34 comprises an EGR valve 36 for selectively restricting exhaust flow from exhaust system 32 to intake system 22, and a heat exchanger (sometimes called an EGR cooler) 38 through which some heat can be rejected from recirculated exhaust to circulating coolant and finally rejected to outside air at a radiator (not shown).

Engine 12 further comprises mechanisms 40, 42, sometimes referred to as variable valve actuation (VVA) mechanisms, for controlling the timing of opening and/or closing of cylinder intake valves 26 and cylinder exhaust valves 28 respectively during engine cycles. The example of VVA mechanisms presented in FIG. 2 comprises a respective mechanism 40 for controlling the timing of opening and/or closing of one or more cylinder intake valves 26 for each engine cylinder 18, and a respective mechanism 42 for controlling the timing of opening and/or closing of one or more cylinder exhaust valves 28 for each engine cylinder 18. Different examples of VVA mechanisms which are not illustrated in the drawings may comprise mechanisms which control cylinder valves of more than one engine cylinder.

Operation of each VVA mechanism 40, 42 is controlled by an engine controller 44 which also controls engine cylinder fueling through control of operation of a fuel injection system which comprises fuel injectors 20.

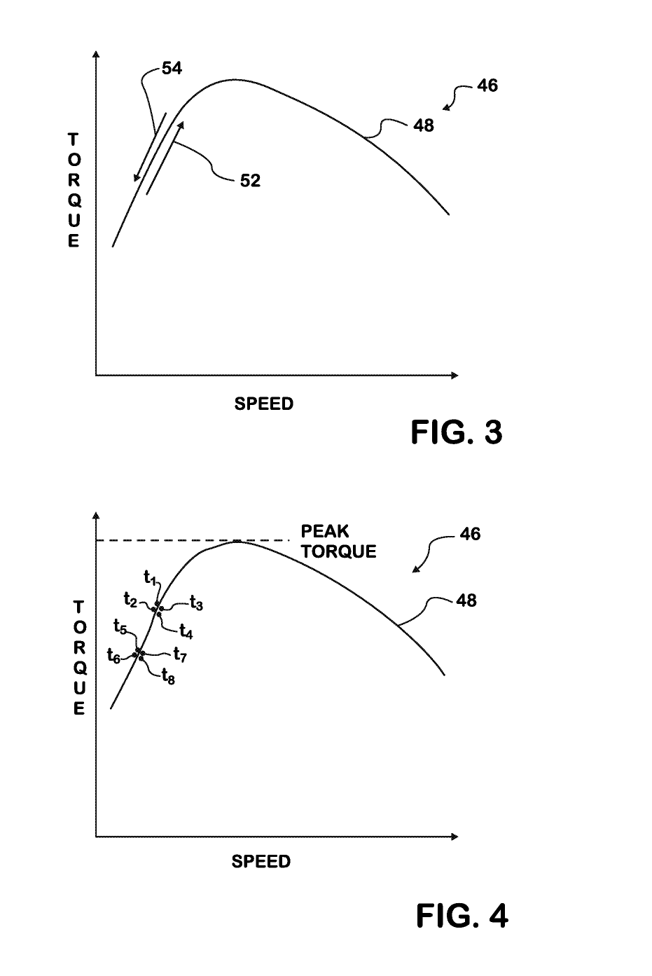

FIG. 3 graphically illustrates a representative engine load model 46 for engine 12 when all engine cylinders 18 are active, i.e. are being fueled. The vertical axis of load model 46 represents engine output torque, and the horizontal axis, engine speed. Engine load model 46 comprises a characteristic torque/speed graph plot 48 correlating engine output torque (i.e. load) and engine speed when all engine cylinders are being fueled in accordance with a fueling strategy contained in engine controller 44.

As engine 12 runs, engine controller 44 compiles a historical record of engine output torque data and engine speed data, which are typically present on a data bus in the electrical system of truck vehicle 10. The historical record is compiled by taking “snapshots” of both engine output torque data and engine speed data at a suitable snapshot rate and storing them in memory. Each snapshot correlates to a point on graph plot 48, and it is the collection of such points which forms the historical record. Engine load model 46 may be embodied as a look-up table in engine controller 44. Engine controller 44 monitors the historical record as engine 12 operates. As portions of the historical record age, they may be erased to conserve on memory.

During vehicle launch and ensuing acceleration caused by depression of an accelerator pedal 50, the fueling strategy in engine controller 44 causes engine torque and speed to increase in the sense of arrow 52 in FIG. 3. A transmission upshift will cause engine torque and speed to decrease in the sense indicated by arrow 54 in FIG. 3, and as accelerator pedal 50 is depressed to continue acceleration, engine output torque will again increase. These changes will be reflected in the historical record which is being compiled.

As the vehicle reaches a cruising speed at a fairly constant load which allows engine 12 to operate somewhere along or near graph plot 48 below peak torque, points of the historical record will tend to cluster as suggested by exemplary data points t1, t2, t3, t4 in FIG. 4.

Engine 12 has been previously mapped to define clusters which indicate that the engine can maintain torque and speed by de-activating at least one engine cylinder 18. When a cluster like the one in FIG. 4 is detected by engine controller 44, the controller initiates an algorithm which controls both fueling of engine cylinders which remain active and timing of cylinder valve operation for the at least one de-activated engine cylinder and possibly cylinder valve operation for at least one engine cylinder which remains active.

In other words, when a cluster like the one in FIG. 4 is detected, the algorithm causes fueling of at least one engine cylinder to cease while maintaining engine torque and speed substantially unchanged through control of fueling and cylinder valve timing. The algorithm causes the timing of operation of the cylinder valves of the at least one inactive engine cylinder to be changed to timing which strives to minimize the pumping losses associated with such cylinder or cylinders, and may also re-adjust the timing of operation of cylinder valves of the engine cylinders which remain active while fueling them with a suitable quantity of fuel to maintain torque and speed.

When the algorithm is initiated, it is effective to convert the engine from a first mode of operation in which the engine operates at its full displacement because all engine cylinders are being fueled to a second mode of operation in which the engine operates as if it were a smaller displacement engine because fewer than all engine cylinders are being fueled and the inactive engine cylinders which are not being fueled impose substantially significantly reduced pumping loss due to the change in timing of their cylinder valves although the inactive cylinders still have some losses due to inertia and friction. With proper calibration, engine 12 can operate in the second mode with reduced fuel consumption and engine-out exhaust emissions than when operating in the first mode.

Should the engine load decrease even further while the engine is operating in the second mode, such as indicated by exemplary data points t5, t6, t7, t8 in FIG. 4 forming a distinctly different cluster from data points t1, t2, t3, t4, then engine operation can be switched from the second mode to a third mode during which at least one additional engine cylinder would be de-activated while the control strategy would fuel the still-active engine cylinders and control timing of operation of engine cylinder valves without significantly affecting the ability of the engine to continue satisfying the load which was being satisfied when the historical record disclosed that the mode could be switched from the second mode to the third mode.

The ability to operate a vehicle's propulsion engine at significantly reduced loads according to the disclosed method may avoid having to equip the vehicle with an APU, thereby avoiding the added cost and weight of such equipment and the issue of packaging it in a vehicle. The disclosed method also provides significant fuel economy improvement for a motor vehicle during various operating conditions which include cruising at fairly steady road speed along relatively flat terrain, temporarily stopping in traffic while the propulsion engine continues to idle, and supplying heat to an occupant compartment and/or electricity to on-board electrical equipment when the vehicle has been parked but the propulsion engine continues to operate.

What is claimed is:

1. An internal combustion engine which comprises:
engine structure forming multiple engine cylinders;
an intake system for conveying air to an intake manifold which serves at least one engine cylinder;
one or more cylinder intake valves for controlling admission of air from the intake manifold into a respective engine cylinder served by the intake manifold;
a fueling system for introducing fuel into the engine cylinders for combustion with air in the engine cylinders to operate the engine;
one or more cylinder exhaust valves for controlling admission of exhaust created by combustion in a respective engine cylinder from a respective engine cylinder into an exhaust manifold serving at least one engine cylinder;
at least one mechanism for varying timing of operation of at least some of the cylinder valves in a group of cylinder valves comprising the one or more cylinder intake valves and the one or more cylinder exhaust valves during engine cycles;
and a controller which, when the engine is miming with all engine cylinders being fueled, compiles a historical record of engine output torque and engine speed, and which, when the historical record discloses a change in engine operation from a relatively greater output torque and engine speed to a relatively lesser output torque and speed, causes fueling of at least one engine cylinder to cease while maintaining engine output torque and engine speed substantially unchanged at the relatively lesser output torque and speed by continuing fueling of other engine cylinders and by causing the at least one mechanism to control the timing of operation of cylinder intake and exhaust valves of the at least one engine cylinder to substantially minimize pumping loss attributable to the at least one engine cylinder.

2. The internal combustion engine set forth in claim 1 comprising an individual mechanism for varying timing of operation of cylinder intake and exhaust valves of each engine cylinder whose fueling ceases when the historical record discloses a change in engine operation from a relatively greater output torque and engine speed to a relatively lesser output torque and speed.

3. The internal combustion engine set forth in claim 1 in which the controller causes the fueling system to cease fueling at least one more engine cylinder than the at least one engine cylinder and the at least one mechanism to control the timing of operation of cylinder intake and exhaust valves of the at least one more engine cylinder to substantially minimize pumping loss attributable to the at least one more engine cylinder when the historical record discloses a change in engine operation from the relatively lesser output torque and speed to a relatively even lesser output torque and speed.

4. A motor vehicle which is propelled by the internal combustion engine set forth in claim 1.

5. A method of operating an internal combustion engine having engine structure forming multiple engine cylinders, an intake system for conveying air to an intake manifold which serves at least one engine cylinder, one or more cylinder intake valves for controlling admission of air from the intake manifold into a respective engine cylinder served by the intake manifold, a fueling system for introducing fuel into the engine cylinders for combustion with air in the engine cylinders to operate the engine, one or more cylinder exhaust valves for controlling admission of exhaust created by combustion in a respective engine cylinder from a respective engine cylinder into an exhaust manifold serving at least one engine cylinder, and at least one mechanism for varying timing of operation of at least some of the cylinder valves in a group of cylinder valves comprising the one or more cylinder intake valves and the one or more cylinder exhaust valves during engine cycles, the method comprising:
while the engine is running with all engine cylinders being fueled, compiling a historical record of engine output torque and engine speed, and when the historical record discloses a change in engine operation from a relatively greater output torque and engine speed to a relatively lesser output torque and speed, causing fueling of at least one engine cylinder to cease while maintaining engine output torque and engine speed substantially unchanged at the relatively lesser output torque and speed by continuing fueling of other engine cylinders and by causing the at least one mechanism to control the timing of operation of cylinder intake and exhaust valves of the at least one engine cylinder to substantially minimize pumping loss attributable to the at least one engine cylinder.

6. The method set forth in claim 5 in which the step of causing the at least one mechanism to control the timing of operation of cylinder intake and exhaust valves of the at least one engine cylinder to substantially minimize pumping loss attributable to the at least one engine cylinder comprises causing an individual mechanism for varying timing of operation of cylinder intake and exhaust valves of each engine cylinder whose fueling ceases when the historical record discloses a change in engine operation from a relatively greater output torque and engine speed to a relatively lesser output torque and speed to vary timing of operation of cylinder intake and exhaust valves of the respective engine cylinder whose fueling ceases when the historical record discloses a change in engine operation from a relatively greater output torque and engine speed to a relatively lesser output torque and speed.

7. The method set forth in claim 5 comprising causing the fueling system to cease fueling at least one more engine cylinder than the at least one engine cylinder and the at least one mechanism to control the timing of operation of cylinder intake and exhaust valves of the at least one more engine cylinder to substantially minimize pumping loss attributable to the at least one more engine cylinder when the historical record discloses a change in engine operation from the relatively lesser output torque and speed to a relatively even lesser output torque and speed.

8. A method of propelling a motor vehicle by a multi-cylinder internal combustion engine coupled to drive wheels through a drivetrain, the method comprising:
while the engine is running with all engine cylinders being fueled, compiling a historical record of engine output torque and engine speed, and when the historical record discloses a change in engine operation from a relatively greater output torque and engine speed to a relatively lesser output torque and speed, causing fueling of at least one engine cylinder to cease while maintaining engine output torque and engine speed substantially unchanged at the relatively lesser output torque and speed by continuing fueling of other engine cylinders and by controlling the timing of operation of cylinder take and exhaust valves of the at least one engine cylinder to substantially minimize pumping loss attributable to the at least one engine cylinder.

9. The method set forth in claim 8 in which the step of controlling the timing of operation of cylinder intake and exhaust valves of the at least one engine cylinder to substantially minimize pumping loss attributable to the at least one engine cylinder comprises causing an individual mechanism for varying timing of operation of cylinder intake and exhaust valves of each engine cylinder whose fueling ceases when the historical record discloses a change in engine operation from a relatively greater output torque and engine speed to a relatively lesser output torque and speed to vary timing of operation of cylinder intake and exhaust valves of the respective engine cylinder whose fueling ceases when the historical record discloses a change in engine operation from a relatively greater output torque and engine speed to a relatively lesser output torque and speed.

10. The method set forth in claim 8 comprising causing fueling at least one more engine cylinder than the at least one engine cylinder to cease and controlling the timing of operation of cylinder intake and exhaust valves of the at least one more engine cylinder to substantially minimize pumping loss attributable to the at least one more engine cylinder when the historical record discloses a change in engine operation from the relatively lesser output torque and speed to a relatively even lesser output torque and speed.
